(19) United States
(12) Patent Application Publication
(10) Pub. No.: US 2018/0168913 A1
(43) Pub. Date: Jun. 21, 2018

(54) PERSONAL MASSAGE APPARATUSES CONFIGURED TO GENERATE STOCHASTIC RESONANCE VIBRATION AND METHODS OF USE

(71) Applicant: Filip Sedic, Shanghai (CN)

(72) Inventor: Filip Sedic, Shanghai (CN)

(21) Appl. No.: 15/838,892

(22) Filed: Dec. 12, 2017

Related U.S. Application Data
(60) Provisional application No. 62/434,685, filed on Dec. 15, 2016.

(51) Int. Cl. A61H 7/00; A61H 23/02

(52) U.S. Cl. CPC A61H 7/002; A61H 2023/002; A61H 23/0254; A61H 23/0218

(57) ABSTRACT

Personal massage apparatuses and methods of use are described herein. An example personal massage apparatus may include two or more motors configured to generate stochastic resonance vibration, which can be delivered to a human body through a first end of the personal massage apparatus. In such an example, a first motor may be vibrationally connected to a second motor provide to constructive or destructive interference of the second motor's vibrational output, producing stochastic resonance vibration. Example personal massage apparatuses may be used to treat one or more of skin, muscle, bone, and/or tissue.

### CROSS REFERENCE TO RELATED APPLICATIONS

This application claims the benefit of U.S. Provisional Patent Application Ser. No. 62/434,685, filed Dec. 15, 2016, which is incorporated into this disclosure in its entirety.

### FIELD

The disclosure relates to the technical field of personal massage apparatuses and methods useful in, for example, massage, activation, treatment, and/or stimulation of a portion of a human body.

### BACKGROUND

The art includes several examples of personal massage apparatuses and methods of using the same. Personal massage apparatuses have been developed in a variety of configurations such that they may effectively and conveniently provide stimulation and/or massage to nearly every part of the human body.

Personal massage apparatuses can perform in several manners. Some personal massage apparatuses include a motor for providing continuous vibration. Other personal massage apparatuses include a motor for providing pulsed vibration or use electromagnetic motors with off-center weights or stockers to produce vibrations that are used for massage. These personal massage apparatuses typically perform at a fixed frequency and vibration pattern.

The vibration provided, though, is limited in its ability to massage, stimulate, and/or treat various portions of the human body. Skin, muscle, and tissue will acclimate to a continuous or patterned vibrational stimulation, reducing stimulation and/or activation of muscle tissue. For example, when a regular, predictable vibrational pattern is applied to a muscle, it becomes acclimated to the pattern of pulses or vibrations. The muscle relaxes and has a smaller response to each pulse or vibration once it becomes accustomed to the pattern. The strength of the response continues to shrink with repeated use over time, which leads to diminished muscular growth with regular use of the massage apparatus.

Stochastic resonance vibration, however, has been shown to prevent acclimation of skin, muscle, and/or tissue to vibrational stimulation, allowing for improved effects of stimulation and/or activation to these portions of the body. Stochastic resonance vibration can provide a random component to the vibrations of a personal massage apparatus and make each vibration unpredictable to the skin, muscle, and/or tissue that receives these vibrations. This allows the skin, muscle, and/or tissue to avoid acclimation to these stimuli, enabling improved activation, massage, and/or stimulation of the desired skin, muscle, and/or tissue. Stochastic resonance vibration, therefore, can help to build muscles under the skin, provide toning to the face, provide symmetry to the face, and bring oxygen and/or to the skin without damaging surface of the skin by causing the target area to more strongly react to stochastic resonance vibrations that would the same portions of the body react to traditional vibrational stimuli. Known personal massage apparatuses are not capable of providing stochastic resonance stimulation to the human body.

What is needed, therefore, is a personal massage apparatus that provides more complex vibrations, such as stochastic resonance vibration, to massage, activate, stimulate and/or treat various portions of the human body.

### BRIEF SUMMARY OF SELECTED EXAMPLES

Various example personal massage apparatuses and methods of use are described and illustrated.

An example personal massage apparatus configured to deliver vibration to a portion of a human body comprises a main body having a first end, a silicone exterior covering substantially all of the main body and defining a first textured surface area integrally forming part of the silicone exterior, the first textured surface area defining a first set of touch-points, each touch-point of the first set of touch-points having a diameter between about 0.5 millimeters and about 2.5 millimeters, a first motor disposed within the main body and configured to generate vibration, a second motor disposed within the main body and adapted to generate vibration, the first motor and the second motor being vibrationally connected and configured to cooperatively generate stochastic resonance vibration in the first end due to vibrational interference between the first motor and the second motor, and at least one user control configured to operate the first motor and the second motor.

Another example personal massage apparatus configured to deliver vibration to a portion of a human body comprises a main body having a first end, a silicone exterior covering substantially all of the main body and defining first and second textured surface areas integrally forming part of the silicone exterior, the first textured surface area defining a first set of touch-points, the second textured surface area defining a second set of touch-points, each touch-point of the first and second sets of touch-points having a diameter between about 0.5 millimeters and about 2.5 millimeters, a first motor disposed within the main body and configured to generate vibration, a second motor disposed within the main body and adapted to generate vibration, the first motor and the second motor being vibrationally connected and configured to cooperatively generate stochastic resonance vibration in the first end due to vibrational interference between the first motor and the second motor, the second motor disposed within the main body such that it is substantially perpendicular to the first motor, and at least one user control configured to operate the first motor and the second motor.

Another example personal massage apparatus configured to deliver vibration to a portion of a human body comprises a main body including a substantially flat base configured to stand unaided on a substantially flat surface, a silicone exterior covering substantially all of an exterior of the main body, the silicone exterior having a first side defining first and second textured surface areas that are integrally formed with the silicone exterior, the first textured surface area comprising a first set of touch-points and the second textured surface area comprising a second set of touch-points, each touch-point of the second set of touch-points having a diameter that is smaller than a diameter of each touch-point of the first set of touch-points, the second set of touch-points being disposed closer to the base than the first set of touch-points, each touch-point of the first set of touch-points and the second set of touch-points having a diameter between about 0.5 and about 2.5 millimeters, a first motor disposed within the main body and configured to generate vibration, a second motor disposed within the main body and adapted to generate vibration, the first motor and the second motor being vibrationally connected and configured to cooperatively generate stochastic resonance vibration in the first end due to vibrational interference between the first motor and the second motor, the second motor disposed within the main body such that it is substantially parallel to the first motor, and at least one user control configured to operate the first motor and the second motor.

Additional understanding of claimed apparatuses and methods may be obtained by reviewing the detailed description of selected examples, below, with reference to the appended drawings.

### DESCRIPTION OF FIGURES

FIG. 1 is an end view of two vibrationally connected motors that may be used in an example personal massage apparatus.

FIG. 1A is an end view of an alternative alignment of the two motors illustrated in FIG. 1.

FIG. 1B is an end view of another alternative alignment of the two motors illustrated in FIG. 1.

FIG. 1C is an end view of another alternative alignment of the two motors illustrated in FIG. 1.

FIG. 1D is an end view of another alternative alignment of the two motors illustrated in FIG. 1.

FIG. 2 is an end view of a first example personal massage apparatus.

FIG. 3 is another end view of the personal massage apparatus illustrated in FIG. 2.

FIG. 4 is a side view of the personal massage apparatus illustrated in FIG. 2.

FIG. 5 is another side view of the personal massage apparatus illustrated in FIG. 2.

FIG. 6 is a top view of the personal massage apparatus illustrated in FIG. 2.

FIG. 7 is a bottom view of the personal massage apparatus illustrated in FIG. 2.

FIG. 8 is a cross-sectional view of the personal massage apparatus illustrated in FIG. 2, taken along line 8-8 in FIG. 2.

FIG. 8A is a cross-sectional end view of an alternative personal massage apparatus.

FIG. 8B is a cross-sectional end view of another alternative personal massage apparatus.

FIG. 8C is a cross-sectional end view of another alternative personal massage apparatus.

FIG. 8D is a cross-sectional end view of another alternative personal massage apparatus.

FIG. 9 is a cross-sectional view of the personal massage apparatus illustrated in FIG. 2, taken along line 9-9 in FIG. 4.

FIG. 9A is a cross-sectional side view of the personal massage apparatus illustrated in FIG. 8A.

FIG. 9B is a cross-sectional side view of the personal massage apparatus illustrated in FIG. 8B.

FIG. 9C is a cross-sectional side view of the personal massage apparatus illustrated in FIG. 8C.

FIG. 9D is a cross-sectional side view of the personal massage apparatus illustrated in FIG. 8D.

FIG. 10 is an end view of the personal massage apparatus illustrated in FIG. 2, with the silicone exterior covering removed from the main body of the personal massage apparatus.

FIG. 11 is a diagram illustrating components of a networked personal massage apparatus in an example embodiment.

FIG. 12 is an end view of another example personal massage apparatus.

FIG. 13 is another end view of the personal massage apparatus illustrated in FIG. 12.

FIG. 14 is an end view of another example personal massage apparatus.

FIG. 15 is another end view of the personal massage apparatus illustrated in FIG. 14.

FIG. 16 is a flowchart representation of an example method of verifying the authenticity of a personal massage apparatus.

FIG. 17 is a flowchart representation of an example method of providing stochastic resonance vibration to a portion of a human body.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF SELECTED EXAMPLES

The following detailed description and the appended drawings describe and illustrate various personal massage apparatuses and methods of use. The description and drawings are provided to enable one skilled in the art to make and use one or more example personal massage apparatus and methods of use. They are not intended to limit the scope of the claims in any manner.

The term “stochastic” as used herein refers to a system whose behavior is intrinsically non-deterministic, sporadic, and/or categorically random. In various embodiments, the personal massage apparatus provides vibrations in a stochastic pattern, i.e., a pattern that is non-deterministic, sporadic, and random, using a plurality of motors.

The term “stochastic resonance vibration” as used herein refers to a vibrational pattern that includes random vibration frequencies and harmonics. In one embodiment, the personal massage apparatus generates stochastic resonance vibration using a combination of at least two motors generating vibrational frequencies.

The term “vibrationally connected” as used herein refers to a configuration between two or more components that generates vibration frequencies that allow vibrational interference between the vibrations generated by each component, resulting in a sum vibrational frequency that is the result of constructive or destructive interference between the vibration frequencies generated by each respective component. Motors that are vibrationally connected can be physically attached or in contact, can be unattached but sufficiently near to at least one other motor that interference can occur between the motors, or can be otherwise positioned in a manner that allows for the generation of stochastic resonance vibration.

The term “activation” as used herein refers to the stimulation of muscle, skin, and/or tissue by stochastic resonance vibration transferred to the muscle, skin, and/or tissue via the personal massage apparatus.

The term “pulse” as used herein refers to a vibrational pulse. These pulses may be delivered in a stochastic (i.e., random) pattern. A “pulse” as used herein may refer to a pulse from a single motor. A pulse or a series of pulses may originate from one motor or a plurality of motors that are vibrationally connected.

The term “frequency” as used herein refers to the vibrational wave frequency over a period of time during a pulse of a personal massage apparatus.

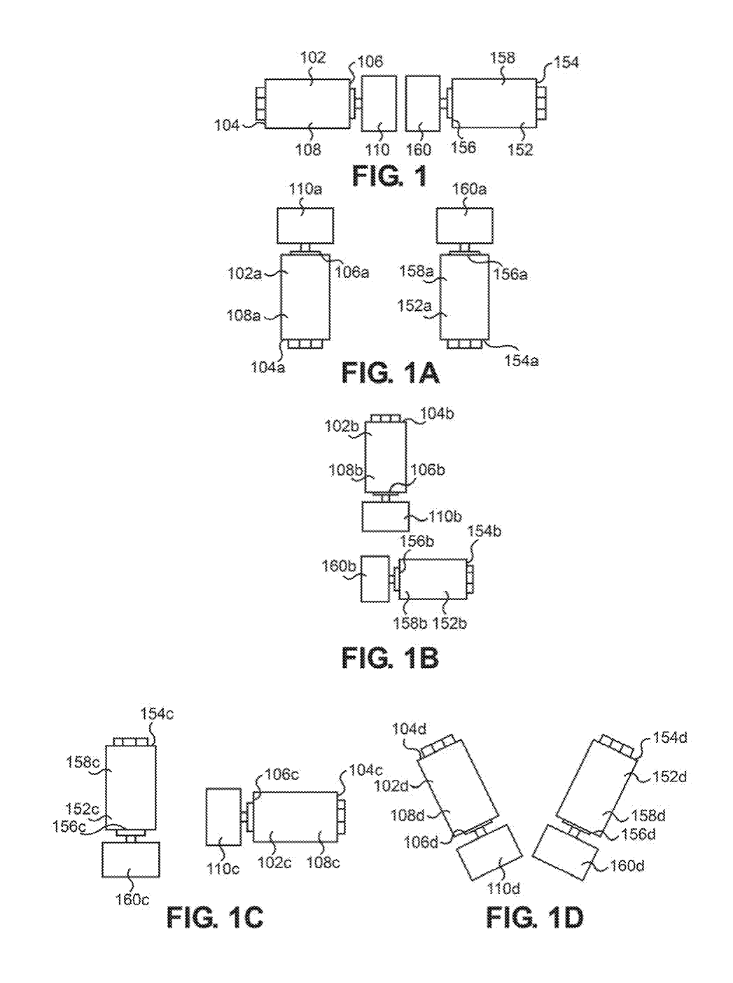

Each of FIGS. 1, 1A, 1B, 1C, and 1D illustrates an example configuration of a first motor 102 and a second motor 152 configured to be disposed within various example personal massage apparatuses (described in greater detail below). The first and second motors 102, 152 provide a vibrational output to the personal massage apparatus, which can then transmit the vibration to the skin, muscle, and/or tissue of a user. The first motor 102 includes a first end 104, a second end 106 opposite the first end 102, a main body 108 extending from the first end 104 to the second end 106, and a first counterweight 110 attached to the second end 106. The second motor 152 includes a first end 154, a second end 156 opposite the first end 152, a main body 158 extending from the first end 154 to the second end 156, and a second counterweight 160 attached to the second end 156.

FIG. 1 illustrates an embodiment in which the first motor 102 and the second motor 152 are substantially parallel with and spatially aligned with one another along a plane bisecting the centers (not illustrated in the Figures) of the main body 108 of the first motor 102 and the main body 158 of the second motor 152. Additionally, the second end 156 of the second motor 152 is substantially adjacent the second end 106 of the first motor 102; accordingly, the first counterweight 110 and the second counterweight 160 are substantially adjacent one another. The first and second motors 102, 152 are vibrationally connected in this embodiment which, therefore, allows for the first and second motors 102, 152 to cooperatively generate stochastic resonance vibrations, as described in greater detail below. A skilled artisan will be able to determine how to suitably align the first and second motors according to a particular example based on various considerations, including the shapes and sizes of the motors and the apparatus into which the motors shall be placed. In another embodiment, the first end of the second motor may be adjacent the first end of the first motor; in such an embodiment, the counterweights shall not be adjacent one another. In a different embodiment, the first end of the first motor may be adjacent the second end of the second motor and, therefore, may be adjacent the counterweight of the second motor. In various other embodiments, the first and second motors may be disposed such that they are “stacked” (or one motor is parallel to the other motor but is placed directly above the other motor relative to the top of a personal massage apparatus), angled to one another, or perpendicular to one another. Additionally, a counterweight may be disposed upon any portion of a motor in various configurations and may be adjacent or abut another motor or counterweight in any suitable manner. An individual counterweight may be larger than, smaller than, or the same size as any other counterweight in various embodiments.

FIG. 1A illustrates an alternative embodiment in which the first and second motors 102a, 152a are aligned in an alternative configuration; the first and second motors 102a, 152a in illustrated in this embodiment are identical to those illustrated in FIG. 1, except for their alignment. In the illustrated embodiment, the first motor 102a and the second motor 152a are substantially parallel to one another and a positioned in a side by side configuration. As illustrated, the second end 154a is adjacent the second end 104a and, consequently, the second counterweight 160a is adjacent the first counterweight 110a. The first and second motors 102a, 152a are vibrationally connected in this embodiment, allowing for the first and second motors 102a, 152a to cooperatively generate stochastic resonance vibrations, as described in greater detail below. A skilled artisan will be able to determine how to suitably align the first and second motors according to a particular example based on various considerations, including the shapes and sizes of the motors and the device into which the motors shall be placed. In another embodiment, the first end of the second motor may be adjacent the first end of the first motor; in such an embodiment, the counterweights shall not be adjacent one another. In a different embodiment, the first end of the first motor may be adjacent the second end of the second motor and, therefore, may be adjacent the counterweight of the second motor. In various other embodiments, the first and second motors may be disposed such that they are “stacked”, angled to one another, or perpendicular to one another. Additionally, a counterweight may be disposed upon any portion of a motor in various configurations and may be adjacent or abut another motor or counterweight in any suitable manner.

FIG. 1B illustrates an alternative embodiment in which the first and second motors 102b, 152b are aligned in an alternative configuration; the first and second motors 102b, 152b illustrated in this embodiment are identical to those illustrated in FIG. 1, except for their alignment. In this embodiment, the first and second motors are substantially perpendicular to one another. FIG. 1B illustrates the first and second counterweights 110, 160 as substantially adjacent one another, with the first motor 102 being disposed above the second motor 152 such that, when disposed within a personal massage apparatus (such as one described below), the first motor 102 would be disposed such that its first end 104 would be closer to the top of such an apparatus than its second end 106. When configured in this manner, the first and second ends 154, 156 of the second motor 152 would be substantially equidistant from the top of such am apparatus.

FIG. 1C illustrates an alternative embodiment in which the first and second motors 102c, 152c are aligned in an alternative configuration; the first and second motors 102c, 152c illustrated in this embodiment are identical to those illustrated in FIG. 1, except for their alignment. FIG. 1C illustrates the first counterweight 110c as disposed adjacent the main body 158c of the second motor 152c; it is not directly adjacent the second counterweight 160c. Furthermore, when disposed within a personal massage apparatus (such as one described below), the second motor 152c would be disposed such that its first end 154c would be closer to the top of such a personal massage apparatus than its second end 156c. When configured in this manner, the first and second ends 104c, 106c of the first motor 102c would be substantially equidistant from the top of such an apparatus. In this embodiment, the first and second motors 102c, 152c are vibrationally connected. In a different embodiment, the first end of the second motor may be adjacent the main body of the first motor and, therefore, may not be adjacent the counterweight of the second motor.

FIG. 1D illustrates an alternative embodiment in which the first motor 102d and second motor 152d are aligned in an alternative manner; the first and second motors 102d, 152d illustrated in this embodiment are identical to those illustrated in FIG. 1, except for their alignment. In this embodiment, the first and second motors 102d, 152d are aligned such that they generally form a V-shape. As illustrated, the second end 106d of the first motor 102d and the second end 156d of the second motor 152d are adjacent one another. Accordingly, in this embodiment, the first and second counterweights 110d, 160d are substantially adjacent one another and are set at an angle to one another. In this embodiment, the first and second motors 102d, 152d are vibrationally connected.

In each of FIGS. 1, 1A, 1B, 1C, and 1D, the first and second motors are configured to produce vibrations that interfere with each other and induce vibrational interference in order to generate stochastic resonance vibration when placed in a personal massage apparatus. The first and second motors may be configured in any suitable alignment, however, in other embodiments. A skilled artisan will be able to determine how suitably to align the first and second motors based on various considerations, including the size, shape, and number of motors, the area of the human body to be treated, and the vibrational pattern desired. In other embodiments, the first and second motors may be in direct contact, may form an X-shape, may be physically attached by any mechanical attachment or any adhesive, and/or may be adjacent one another but not in contact such that they are vibrationally connected. In other embodiments, an example personal massage apparatus may include one, two, three, four, five, or more than five motors.

In the embodiments illustrated in FIGS. 1, 1A, 1B, 1C, and 1D, the first and second motors 102, 152 cooperatively generate stochastic resonance vibration, which in turn vibrates at least one portion of a personal massage apparatus designed to contact a user. More specifically, the first and second motors 102, 152 are able to produce stochastic resonance vibration through activation of their respective first and second counterweights 110, 160 (after activation of the motors 102, 152) relative to the motors 102, 152 at different intervals, frequencies, amplitudes, strengths, durations, and/or times (as further described below). Examples of how to generate said stochastic resonance vibrations are discussed in greater detail below. A skilled artisan will be able to determine how to suitably generate stochastic resonance vibration based on various considerations, including the size, shape, and number of motors, the portion of the human body to be treated, and the vibrational pattern desired. In some embodiments, the motors may generate vibrational frequency. In alternative embodiments, the motors generate rotational frequency. In various embodiments, one or more of the motors may be electromagnetic motors or any other type of motor.

In some embodiments, at least one motor may work on a different frequency or pattern than that of another motor to interfere with the vibrations generated by the other vibrationally connected motor. For example, one motor may vibrate constantly or periodically in a repeatable pattern, while the other motor may vibrate in short, random pulses. This can result in stochastic resonance vibration based on the random interference generated by the pulses of the second motor and the continuous or patterned vibration of the first motor. In another embodiment, both motors may individually generate stochastic resonance vibration by providing short, random pulses, which cooperatively generate stochastic resonance vibration. In a different embodiment, one motor may provide a continuous or varied non-stochastic pattern of pulses, while the other motor generates stochastic pulses. Additionally, one or both motors may produce a regular or continuous pattern of vibration, and may be combined with a motor that generates stochastic vibration through one or more of a variation in pulse or frequency, for example.

Stochastic resonance can also be achieved in the motors through other mechanisms, such as through random variation of frequency, random variation of amplitude, and random variation of pulse frequency of vibrations. In other embodiments, both motors can generate varying vibrational frequencies, with at least one of the motors varying according to a stochastic pattern. In another embodiment, one motor generates a constant vibrational frequency, while the other motor generates vibrational frequencies that vary according to a stochastic pattern of variance. In yet another embodiment, one motor vibrates constantly while the other produces vibrations of randomly varying amplitude. In various embodiments, one or each of the motors may vibrate at a frequency between about 1 Hertz (“Hz”) and about 200 Hz, between about 10 Hz and about 150 Hz, and between about 50 Hz and about 150 Hz. In different embodiments, pulse frequencies of one or both motors may differ so that the motors operate in a discontinuous manner; in said embodiments, the pulse frequencies for one or each of the motors may be between about 1 Hz and about 100 Hz, for example.

Furthermore, in different embodiments pulse duration may be constant or may vary stochastically or according to a regular pattern in various embodiments. In an example embodiment, pulse duration may be between about 10 microseconds and about 1,000 microseconds. In various embodiments, one or each of the motors may vibrate for a duration that differs from the duration of another motor's vibrations by between about 1 microsecond and about 1000 microseconds, between about 10 microseconds and about 500 microseconds, and between about 50 microseconds and about 150 microseconds.

In other embodiments, in which more than two motors may be used, one motor may be programmed to exhibit a stochastic vibration pattern, while others do not; in these embodiments, all, none, or only some of the motors may be vibrationally connected. In alternative embodiment, the motors oscillate vibrational frequency or provide a varying pattern of pulses in such a way that makes the output seem stochastic to a user's muscle and/or tissue, while each of the motors follows a specific vibrational pattern.

In various embodiments, stochastic resonance vibrations may be generated to match the stochastic resonance energy suitable for the activation of a specific skin, muscle, and/or tissue. For example, stochastic resonance vibrations specifically suited for the heart, kidney, skin, lymph nodes, facial tissues, or any other portion of the body may be generated by the motors of the personal massage apparatus. A skilled artisan will be able to determine a suitable manner of generating stochastic resonance vibrations based on various considerations, including the stochastic energy required for activation of a particular body part and the configuration of the motors. In one embodiment, the personal massage apparatus generates stochastic resonance vibrations designed to activate facial muscles to increase facial muscle tone. In another embodiment, the personal massage apparatus generates stochastic resonance vibrations designed to treat disorders such as incontinence (e.g., by strengthening floor pelvic muscles), Parkinson's (e.g., by strengthening muscle tissue), and/or cachexia (i.e., muscle wasting). In other embodiments, the personal massage apparatus may be configured to generate stochastic resonance vibrations that aid in bringing oxygen and blood to the skin by massaging the skin, developing muscles that hold the skin and allowing the skin to be more toned around the face or eyes, for example. In another embodiment, a specific resonance energy may be provided by the personal massage apparatus to treat disorders such as kidney stones or heart conditions. This may be achieved through the generation of multiple frequencies from the two or more motors of the personal massage apparatus, providing simultaneous resonant frequencies to enhance treatment of the disorder. In still other embodiments, the personal massage apparatus may be used to stimulate bone growth. In certain embodiments, the personal massage apparatus may be used to treat nervous tissue.

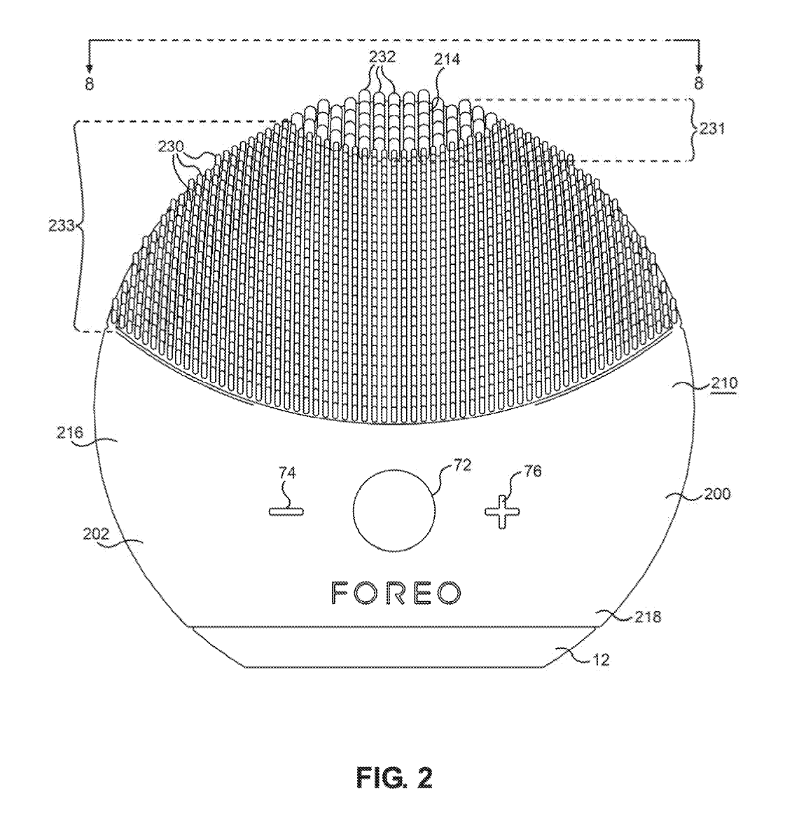

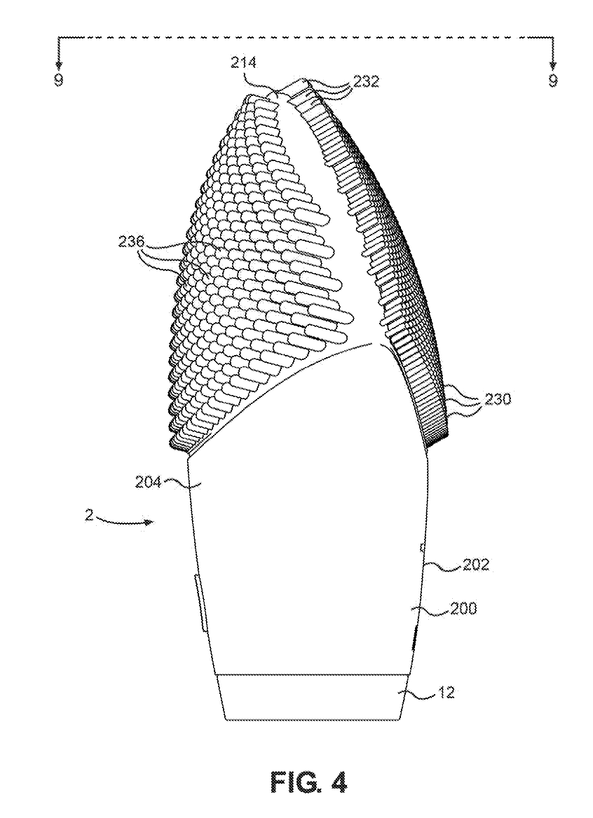

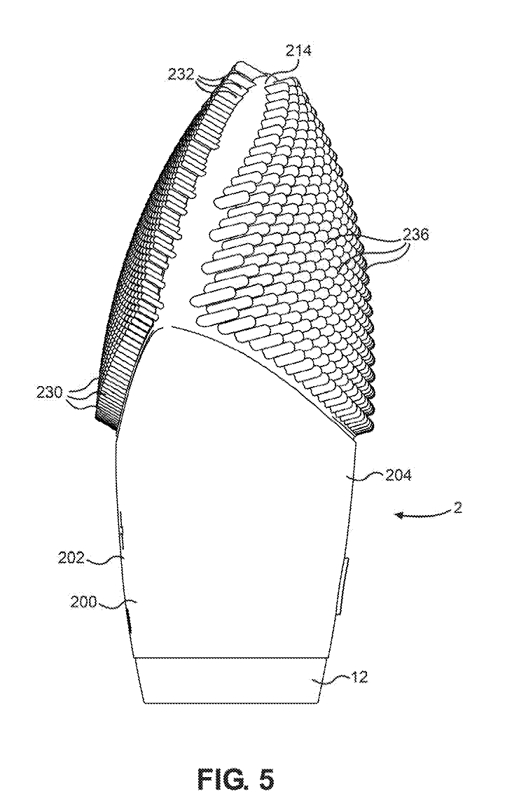

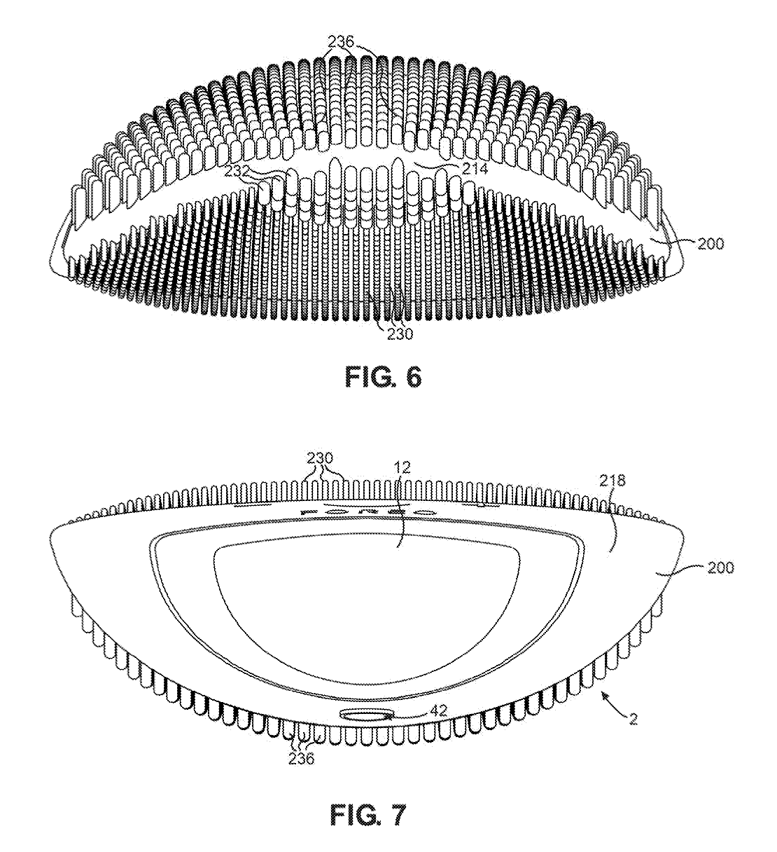

FIGS. 2, 3, 4, 5, 6, 7, 8, 9, and 10 illustrate an example personal massage apparatus 2 in which stochastic vibrations are generated via the first and second motors 102, 152, as described above. In this embodiment, the personal massage apparatus 2 comprises a main body 10 and an exterior covering 100. The main body 10 houses various components (described below) and includes a base 12. The embodiment illustrated in FIGS. 2 through 10 includes a first motor 102 and a second motor 152, as described above, and they are aligned in the configuration illustrated in FIG. 1. The base 12 is substantially flat and is configured such that the personal massage apparatus 2 may stand unaided and without assistance from another device or implementation when placed on a relatively flat surface, such as a table. The main body 10 is comprised of plastic in this embodiment; however, in other embodiments, other suitable materials may comprise the main body. The main body 10 also is firm enough such that it cannot be deformed to a large degree by a user when in use. A skilled artisan will be able to determine how to suitably configure the main body and the base based on various considerations, including the size and shape of the personal massage apparatus and the desired power source. In various embodiments, the personal massage apparatus may include one, two, three, or more than three pieces. In a different embodiment, any number of pieces forming the main body and the base may be attached via any physical mechanism, such as through being specifically configured to snugly attach to one another, or through the use of an adhesive. In an alternative embodiment, the main body may be a single, integral piece. In another embodiment, the base may not be flat, and the personal massage apparatus may not be able to stand unassisted on substantially flat surfaces.

The main body 10 defines a cavity 14, which houses a controller 30, a power source 40, and the first and second motors 102, 152. The main body 10 may have any suitable shape. A skilled artisan will be able to select a suitable shape for the main body according to a particular example based on various considerations, including the strength of the motors and facial shapes of prospective users. In various embodiments, the main body can be configured to have different shapes, such as a substantially oval shape, a substantially round shape, a triangular shape, a substantially leaf-like shape, a curved shape, and so forth. The oval or round shape of the body, for example, allows the user to hold the personal massage apparatus in the palm of the hand, possibly with fingers splayed along the back side of the personal massage apparatus and thumb against the controls in the front side of the personal massage apparatus. In some embodiments, the personal massage apparatus is wider than it is thick. This configuration allows the user to easily hold the personal massage apparatus in the palm of the hand and reach her fingers around both side of the personal massage apparatus for easy and ergonomic manipulation of the personal massage apparatus against the skin.

Each of the first and second motors 102, 152 is enclosed in a frame within the main body 10, and, specifically, within the cavity 14. As noted above, they are disposed relative to one another as described in FIG. 1 and various preceding paragraphs. The first motor 102 is disposed within a first frame 120 and the second motor is disposed within a second frame 170, each of which help to maintain the first and second motors 102, 152 in position within the personal massage apparatus 2. The controller 30, provides instructions to the first and second motors 102, 152, which are powered by the power source 40. The first and second motors 102, 152 function as described above to produce stochastic resonance vibrations which are transferred to user via the personal massage apparatus 2. When the personal massage apparatus 2, and the exterior covering 100 in particular, is applied to the body, such as the face or neck, the pulsations provide a thorough cleaning and/or massaging of the skin.

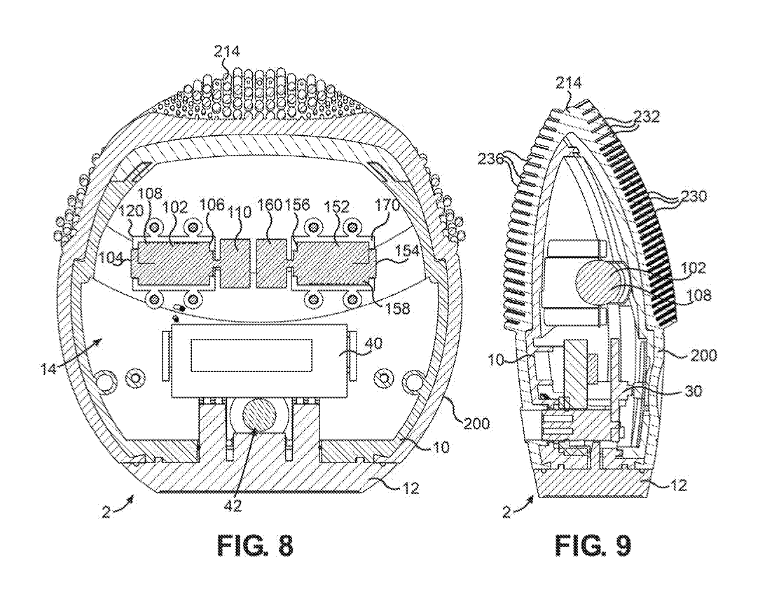

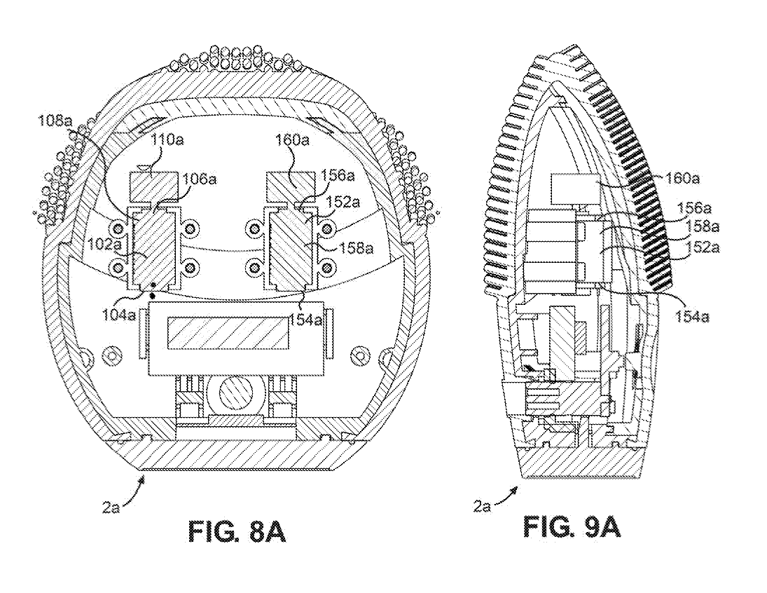

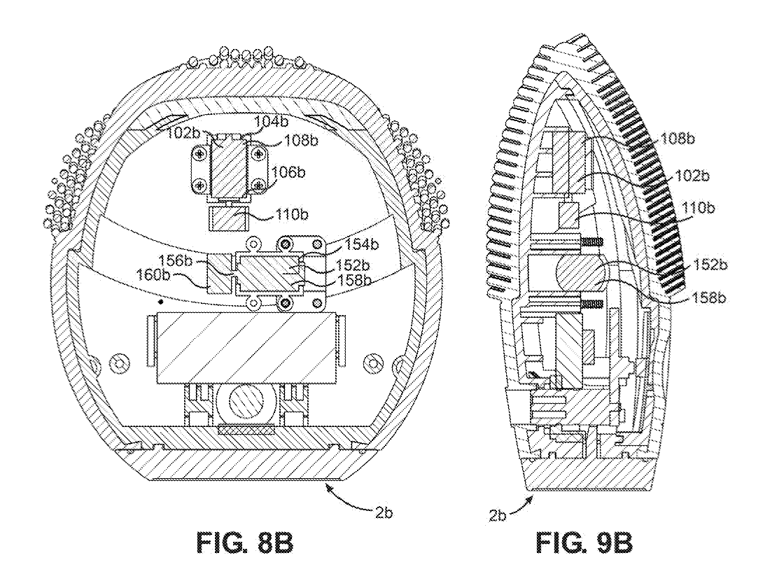

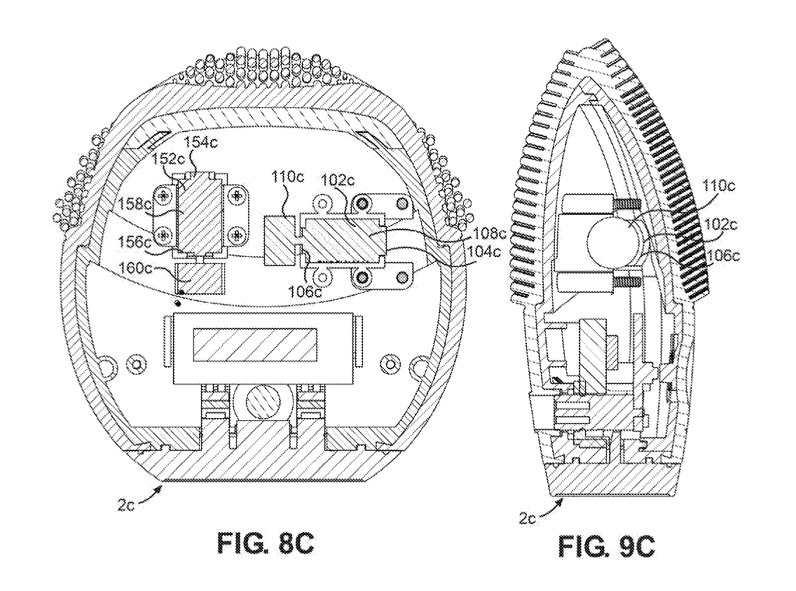

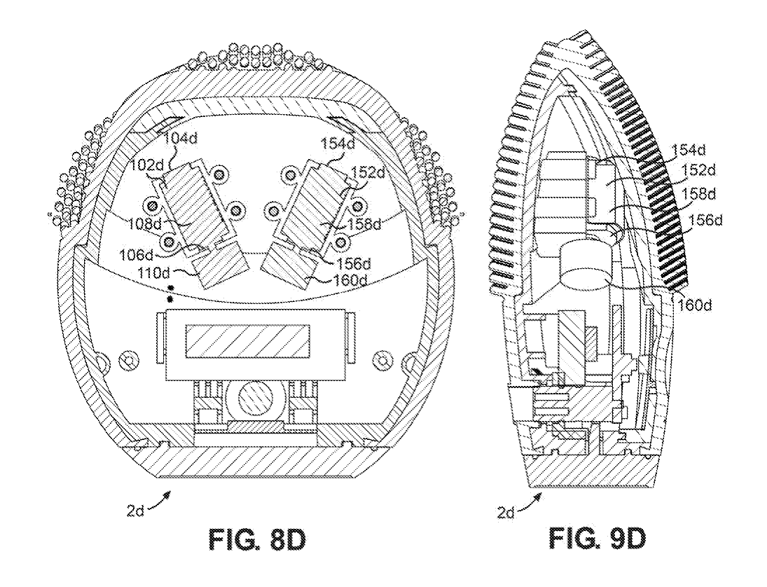

FIGS. 8A and 9A illustrate an alternative personal massage apparatus 2a. The personal massage apparatus illustrated in FIGS. 8A and 9A has the same components as those illustrated in FIGS. 2 through 10, including a first motor 102a having a first end 104a, a second end 106a, a main body 108a, and a counterweight 110a and a second motor 152a having a first end 154a, a second end 156a, a main body 158a, and a counterweight 160a; however, the first and second motors 102a, 152a are aligned differently in the illustrated embodiment. More specifically, the first and second motors 102a, 152a are disposed in the manner illustrated in FIG. 1A and described in the preceding paragraphs in this alternative embodiment. As described above, the alignment of the first and second motors 102a, 152a illustrated in FIGS. 8A and 9A allows for the generation of stochastic resonance vibrations.

FIGS. 8B and 9B illustrate an alternative personal massage apparatus 2b. The personal massage apparatus illustrated in FIGS. 8B and 9B has the same components as those illustrated in FIGS. 2 through 10, including a first motor 102b having a first end 104b, a second end 106b, a main body 108b, and a counterweight 110b and a second motor 152b having a first end 154b, a second end 156b, a main body 158b, and a counterweight 160b; however, the first and second motors 102b, 152b are aligned differently in the illustrated embodiment. More specifically, the first and second motors 102b, 152b are disposed in the manner illustrated in FIG. 1B and described in the preceding paragraphs in this alternative embodiment. As described above, the alignment of the first and second motors 102b, 152b illustrated in FIGS. 8B and 9B allows for the generation of stochastic resonance vibrations.

FIGS. 8C and 9C illustrate an alternative personal massage apparatus 2c. The personal massage apparatus illustrated in FIGS. 8C and 9C has the same components as those illustrated in FIGS. 2 through 10, including a first motor 102c having a first end 104c, a second end 106c, a main body 108c, and a counterweight 110c and a second motor 152c having a first end 154c, a second end 156c, a main body 158c, and a counterweight 160c; however, the first and second motors 102c, 152c are aligned differently in the illustrated embodiment. More specifically, the first and second motors 102c, 152c are disposed in the manner illustrated in FIG. 1C and described in the preceding paragraphs in this alternative embodiment. As described above, the alignment of the first and second motors 102c, 152c illustrated in FIGS. 8C and 9C allows for the generation of stochastic resonance vibrations.

FIGS. 8D and 9D illustrate an alternative personal massage apparatus 2d. The personal massage apparatus illustrated in FIGS. 8D and 9D has the same components as those illustrated in FIGS. 2 through 10, including a first motor 102d having a first end 104d, a second end 106d, a main body 108d, and a counterweight 110d and a second motor 152d having a first end 154d, a second end 156d, a main body 158d, and a counterweight 160d; however, the first and second motors 102d, 152d are aligned differently in the illustrated embodiment. More specifically, the first and second motors 102d, 152d are disposed in the manner illustrated in FIG. 1D and described in the preceding paragraphs in this alternative embodiment. As described above, the alignment of the first and second motors 102d, 152d illustrated in FIGS. 8D and 9D allows for the generation of stochastic resonance vibrations.

The stochastic resonance vibrations provide a tapping motion to the skin, in some embodiments, by providing impulses to the skin's surface from the silicone touch-points (described below) pulsating against the skin's surface. Additional benefits can range from stimulating collagen synthesis in fibroblast cells to improving the flow of blood and lymphatic fluid—the result is healthier, younger-looking skin, such as in the known problem areas of the face, and a more sharply defined profile of the face. In particular, when gently applied to expression-line problem areas at the brow, temples and nasolabial folds, the personal massage apparatus can relax underlying muscles and reduce the appearance of dynamic wrinkles when such frequencies are used.

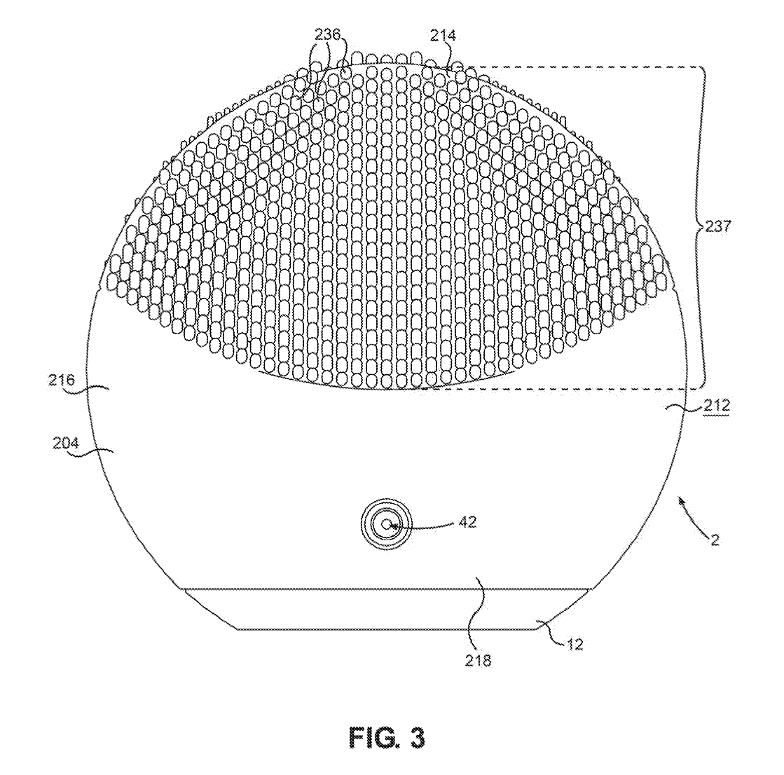

The power source 40 is also disposed within the cavity 14 of the main body 10. The power source 40 provides power to each of the controller 30 and the first and second motors 102, 152. In the illustrated embodiment, the power source 40 comprises a rechargeable lithium-ion battery disposed within the cavity 14 of the personal massage apparatus 2. The power source 40 may be charged through a charging port, such as DC jack 42, best illustrated in FIG. 3. A skilled artisan will be able to determine a suitable power source according to a particular example based on various configurations, including the size and strength of the motor and the size of the personal massage apparatus. In other embodiments, the power source may comprise one, two, three, or more than three replaceable dry cell batteries. In various examples, the batteries may be Single A, Double A, Triple A, or any other suitable type of battery.

Optionally, in an alternative embodiment, one or more sensors are also included in the personal massage apparatus near the front and/or back of the personal massage apparatus (not illustrated in the Figures). The sensors may be pressure sensors, or similar components, that detects a user's action to activate the sensors, such as by contacting the body exterior to the sensor. Alternatively, sensors may be included that measures the moisture content of a user's skin. In one embodiment, the controller activates at least one of the motors when the sensors are activated, permitting the apparatus to automatically activate when the user activates the sensors. Multiple sensors may be included to activate different functions. For instance, in one configuration a sensor is located underneath each textured side of the personal massage apparatus and detects contact with that textured side. Based on which sensor is activated, the controller activates an operational mode suitable for the side on which the sensor was activated. For example, activating the motor at a low frequency when one side is contacted, and activating the motor at a high frequency when the other side is contacted.

The main body 10 also houses the controller 30, which is disposed within the main body 10. The controller 30 is operatively connected to the first and second motors 102, 152 and provides instructions to the same. The controller 30 in the illustrated embodiment includes a printed circuit board assembly (“PCBA”) and related circuitry; however, in other embodiments, the controller may comprise any device suitable to control the personal massage apparatus' components, such as a printed circuit board (“PCB”). Additionally, the controller 30 is operatively connected to an interface 35 which allows it to communicate with a second device (described in greater detail, below).

The main body 10 also includes a set of user controls 70 that allow a user to operate the personal massage apparatus 2. The user controls 70 are disposed on the front of the main body 10 and are operatively connected to the controller 30. The user controls 70 include three buttons in the illustrated embodiment, which allow for a user to active the personal massage apparatus 2 by pressing various buttons. The first button 72 allows for a user to power on and power off the personal massage apparatus 2. The second and third buttons 74, 76 allow for a user to increase and decrease the vibrational output of the personal massage apparatus 2. Optionally, repeated activation of the user controls 70 allows for a user to cycle through various modes of operation of the personal massage apparatus. Potential modes that may be activated by the user controls 70 include low frequency mode, high frequency mode, and alternating frequency mode. The user controls 70 may be accessed through the exterior covering 200; for ease of reference, the exterior covering's 200 symbols showing the placement of the user controls 70 shall use the same numbering described in this paragraph. A skilled artisan will be able to suitably place the user controls on the apparatus and configure the same according to a particular example based on various considerations, including the number of desired modes and the desired placement of the touch-points of the silicone exterior. In other embodiments, the user control may be disposed on the rear of the main body, the side(s) of the main body, or the base of the main body. In a different embodiment, the personal massage apparatus may comprise zero, one, three, or more than three user controls.

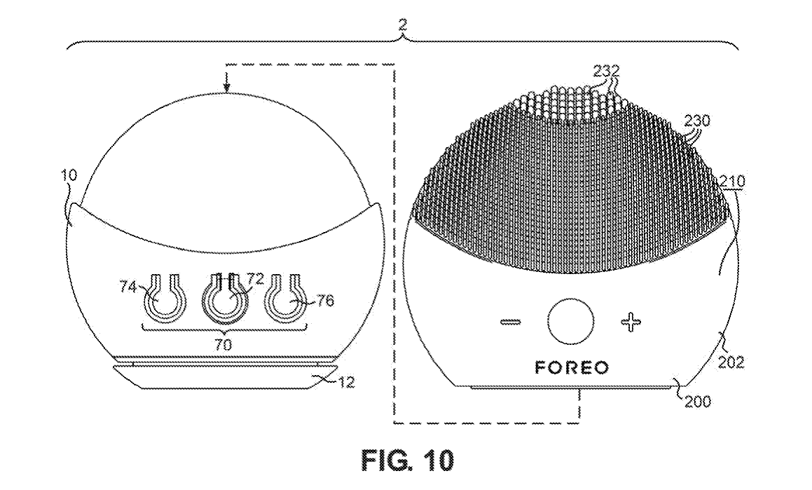

FIG. 10 best illustrates the exterior covering 200 when it is separate from the main body 10. Various other Figures clearly illustrate the exterior covering 200 once it has been placed about the main body 10. The exterior covering 200 comprises a single, unitary piece in this embodiment. The exterior covering 200 can be comprised of various elastic materials, preferably materials that are soft and do not damage the skin, such as silicone. Silicone is used as an example throughout, though it is understood that other materials can be used, as well. The exterior covering 200 is made of a hygienic silicone that is fast-drying and non-absorbent, allowing the personal massage apparatus 2 to be used with many skin products without wear. The exterior covering 200 includes a front surface 210 on a first exterior covering side 202 and a back surface 212 on a second exterior covering side 204 having varying textures. The exterior covering 200 also includes an upper portion 214, a middle portion 216, and a lower portion 218 and may define various structures on said front and back surface 210, 212.

For example, the front surface 210 comprises a series of thinner touch-points 230 (grouped in a second textured surface area 233) and an area of thicker touch-points 232 (grouped in a first textured surface area 231) disposed towards the upper portion 214 of the exterior covering 200. The thinner touch-points 230 and thicker touch-points 232 may vary in size and spacing. Thus, the thinner touch-points 230 and thicker touch-points 232 can also be arranged differently about the front surface 210 than is illustrated. Additionally, the thinner and/or thicker touch-points 230, 232 and/or the main body 10 of the personal massage apparatus 2 itself may be slightly to moderately compressible and bendable, such that the thinner and thicker 230, 232 touch-points and/or main body 10 of the personal massage apparatus 2 conform to the surface of the skin during use; the main body 10, however, may be not bend or molded in any way a user chooses due to its solid structure. The second exterior covering side 204 includes a third series of touch-points 236 (grouped in a third textured surface area 237) extending from the upper portion 214 to the middle portion 216 of the exterior covering 200. These touch-points 236 are similar in size and shape to the thicker touch-points 232, but may have other shapes, sizes, and/or configurations in various other embodiments.

A skilled artisan will be able to determine how to suitably shape, size, and place the various touch-points according to a particular example based on various considerations, including the skin type of potential users and the size and shape of the personal massage apparatus. In various embodiments, the thinner touch-points may be between about 25% and about 80% thinner (e.g., 30%, 40%, 50%, 60%, 70%, etc. or values in between) than the thicker touch-points. In various embodiments, the thinner touch-points may be disposed closer together (i.e., the distance between touch-points), such as between about 15% and about 60% closer to one another, as compared to the thicker touch-points. Thus, the thinner and thicker touch-points can also be arranged differently around the brush surface than is illustrated.

In various embodiments, the touch-points may be between about 0.5 millimeters (“mm”) in diameter and about 4.5 mm in diameter, between about 1.5 mm in diameter and about 3.5 mm in diameter, and between about 2 mm in diameter and about 3 mm in diameter. The textured portion of the exterior covering can comprise between about 5% and about 80% of the exterior covering, between about 20% and about 60% of the exterior covering, and between about 30% and about 50% of the apparatus according to various embodiments. The textured portion can be positioned on a top of the exterior covering, such as is illustrated in the Figures, but can also be otherwise positioned (e.g., at the sides, in the middle, at the bottom of the personal massage apparatus). In one embodiment, one or more portions of the exterior surface, e.g., the textured surfaces, are deformable or bendable. For example, where a textured surface is composed of silicone, the surface can compress or bend when pressed against the skin to mold to the surface of the skin for providing a deeper massage of skin surfaces that are curved. In other embodiments, the textured surface can be designed to pivot relative to the brush or to include one or more portions that pivot such that it can mold to the shape of the face. In other embodiments, the exterior covering may be comprised of many materials, including any suitable elastomeric material. In various embodiments, the thinner and/or thicker touch-points may be between about 0.5 millimeters (“mm”) in height and about 6 mm in height, between about 1.5 mm in height and about 5.5 mm in height, and between about 2.5 mm in height and about 4.5 mm in height.

Furthermore, the Figures provide just one example of how the thinner 230 and thicker 232 and third series 236 of touch-points on the exterior covering 200 can be arranged. In other embodiments, a variety of other arrangements are also possible (e.g., thinner touch-points at the top and thicker at the bottom, thinner on one side and thicker on the other side, alternating rows of thinner and thicker, various areas or groupings of thinner and thicker in different locations on the brush, and so forth). In addition, different types of touch-points can be included, such as taller or shorter touch-points, touch-points with more or less bulbous ends, touch-points with ends of different shapes (e.g., pointed, feathered, ridged, etc.), and so forth. Similarly, the touch-points can be arranged more or less densely, can be positioned on both the front and back of the brush, can be otherwise located on the brush (e.g., only in the middle, only at the edges, etc.), among other variations. The above are just some examples of different brush surface configurations matched to different skin types. In some embodiments, the front textured surface includes at least two different types of touch-points (e.g., thicker and thinner). The touch-points of a type can be grouped to provide a pattern. In other embodiments, the third side may not include any touch-points, or it may include one or both of touch-points comparable in size and/or shape to the thicker and/or thinner touch-points.

The exterior covering 200 is designed to efficiently channel the high-frequency vibrations into the skin to boost circulation and lymph flow. By avoiding abrasive contact (as used in other massage devices), it remains gentle enough to use for twice-daily or more uses in the day, as needed. Relative to other devices, this personal massage apparatus 2 does not rely on a spinning or twisting action; the result is a deeper massage.

As described above, the controller 30 also controls an interface 35 that allows the personal massage apparatus 2 to communicate with a second device, such as a personal computer, tablet, mobile telephone, or other electronic device (not illustrated in the Figures). Using the interface 35, the personal massage apparatus 2 can send information to other devices so that the other device(s) may collect data pertaining to the use of the personal massage apparatus 2. Additionally, the personal massage apparatus 2 may receive control signals from another device that can indicate that the personal massage apparatus 2 should turn on or off, increase or decrease speed, switch to a different vibration pattern, and/or switch to a particular pattern desired by the user or recommended by the other device, among other instructions. The interface 35 can be a wired or wireless interface, such as a wireless transceiver that transmits control signals between the personal massage apparatus 2 and a second device. A skilled artisan will be able to select a suitable interface based on various considerations, including the device with which the personal massage apparatus will communicate and the size and shape of the main body. In some embodiments, the interface is a radio-frequency (“RF”) transceiver used to transmit and receive RF signals between the personal massage apparatus and other devices. One example of an RF transceiver that could be used is a low power 2.4 GHz RF transceiver. In various embodiments, the personal massage apparatus may also include antennas for transmitting and receiving signals between the personal massage apparatus and other devices. In such examples, the interface can use BLUETOOTH®, Wi-Fi, infrared, laser light, visible light, acoustic energy, or one of a number of other methods to transmit information wirelessly between the personal massage apparatus and another device.

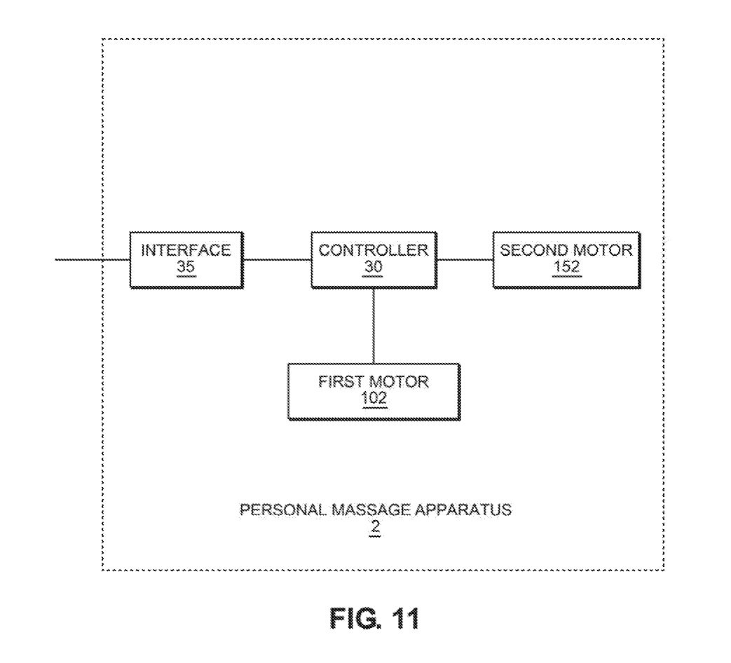

In some embodiments, the personal massage apparatus is connected to a network via the second device. In other embodiments, the personal massage apparatus is directly connected to a wireless router or cellular phone network and may connect with the second device in any of said manners. Accordingly, the personal massage apparatus can be controlled via personal computer, tablet, mobile phone, or other suitable electronic devices a user using the personal computer, tablet, phone, or other device. FIG. 11 illustrates one example of such a design.

FIG. 11 is a diagram illustrating components of a networked personal massage apparatus, such as personal massage apparatus 2, in accordance with an example embodiment. In this embodiment, the personal massage apparatus includes a controller, such as controller 30, motors, such as first and second motors 102, 152, and an interface, such as interface 35. As explained above, the personal massage apparatus can be connected to a network via a personal computer, tablet, mobile telephone, or other electronic device or can be directly connected to a wireless router or cellular phone network. Thus, the personal massage apparatus can be controlled by, transmit data to, and/or receive data from the personal computer, tablet, mobile telephone, or other electronic device via the aforementioned mechanisms. The interface may be wired or wireless and may include any of those described above. A skilled artisan will be able to determine how to suitably connect the personal massage apparatus with other devices based on various considerations, including the desirability of doing so and the devices to which connection would be beneficial. In some embodiments, the personal massage apparatus may not include an interface and, thus, may not communicate with other devices. In different embodiments, the personal massage apparatus may only transmit data to other devices; it may not receive any data and cannot be controlled via said other devices in such embodiments.

Examples of data that the personal massage apparatus may communicate to one or more of a personal computer, tablet, mobile telephone, or other electronic device may include the moisture content of a user's skin, the relative skin age of a user's skin, the elasticity of a user's skin, the presence or absence of wrinkles on a user's skin, and/or the presence and/or absence of acne or other similar skin conditions on a user's skin.

In use, a user interacts with the controller 30 through the user controls 70. When activated by the user controls 70, the controller 30 initiates the vibration of the first and second motors 102, 152. Optionally, the user may increase and decrease the frequency of vibration of the motors 102, 152 through the user controls 70 to set the frequency desired by the user. In such instances, the frequency set by the user may be stored by the controller 30 when the controller 30 is deactivated, such that the next time the controller 30 is turned on the controller 30 resumes the desired frequency.

Various other modes of use also exist. In an example embodiment, a personal massage apparatus may also activate a mode that directs the user to cycle through portions of the face when applying vibrations through the personal massage apparatus. The base of the personal massage apparatus may light up or otherwise indicate a prompt for the user to move to another portion of the face. As an example, the personal massage apparatus may first indicate that the user should apply the personal massage apparatus to the area around the cheeks for a period of time, and then may indicate that the user should apply the personal massage apparatus to the area around the chin, and so forth until the user has cycled throughout the face. The personal massage apparatus can indicate when it is time to switch by, for example, lighting up the base, blinking the light a certain number of times, or otherwise using the light to indicate instructions to the user. Alternatively, a decorative design could emit light to indicate it is time for a user to change placement of the device on the face. Different massage regimens can be used for different devices. For example, a sensitive personal massage apparatus might have a cycle that is shorter in certain areas of the face to avoid irritating the face. A user might also have a program designed specifically for the user's own skin, with shorter or longer application of the device to different areas of the face as needed for that user's skin. The program designed for a user's skin may be assessed by the manufacturer and programmed to the controller according to a diagnostic of the user's particular skincare routine.

In various embodiments, and as described above, the controller can transmit data from the personal massage apparatus (and through the interface) to other devices, such as a personal computer, tablet, or mobile phone (not illustrated in the Figures). Said other devices can then analyze the data sent by the personal massage apparatus and indicate to the user how to optimally use the personal massage apparatus in the future.

For example, a personal massage apparatus, such as personal massage apparatus 2, may transmit user usage data to a mobile phone having a software application that allows a user to view the data transmitted from the personal massage apparatus to the mobile phone. Based on the data received from the personal massage apparatus (such data related to number of uses and duration of uses, for example), the mobile phone application may recommend to the user any number of courses of action, including, but not limited to: using the personal massage apparatus more frequently, using the personal massage apparatus less frequently, using the personal massage apparatus for a longer period of time during an individual use, using the personal massage apparatus for a shorter period of time during an individual use, and using the personal massage apparatus on a particular area of the body. Furthermore, the mobile phone may be able to recommend various creams, lotions, and/or beauty products to use that will enhance the user's skin based on the data collected. Of course, said applications or computer programs can be stored on any suitable electronic device; a mobile phone is not necessary for this process. A skilled artisan will be able to determine how best to integrate the personal massage apparatus with an application on another device according to a particular example based on various considerations, including the type of device to be integrated and the particular controller of the personal massage apparatus. In other embodiments, an application may suggest coating the exterior covering and other user-contacting portions of the personal massage apparatus with active ingredients, such as vitamin E, antioxidants, or silver nanoparticles. Additionally, with or without input from the application, the exterior covering can be coated with these ingredients by the user or pre-coated, or can have a delivery mechanism in the personal massage apparatus that can store and provide these ingredients upon use in other embodiments.

Additional features may also be included in the personal massage apparatus in other embodiments. In one embodiment, the personal massage apparatus includes a heat-emitting source located between the main body and the textured surfaces. The heat-emitting source, when activated by the controller, heats the textured surfaces and may be used in conjunction with the oscillations of the touch-points. In a further embodiment, the personal massage apparatus includes a dosing mechanism integrated in the body of the device to dispense liquids or solid suspensions, such as for the delivery of silver nanoparticles, Vitamin E, etc. as described above. The dosing mechanism may include a reservoir, for example at the base of the personal massage apparatus, and a pump with an outlet to dispense contents of the reservoir to the textured surfaces or near the textured surfaces.

Another example optional feature that may be included with a particular personal massage apparatus, such as personal massage apparatus 2, is a security mechanism. In such an embodiment, the controller of the personal massage apparatus, such as controller 30, may include a scannable serial number. The serial number may be housed in the memory of the controller. After connecting with a second device, such as a personal computer, tablet, and/or mobile phone, the controller can send signals to the second device indicating the serial number. The connection may be made wirelessly or via wired connection.

The second device can then instruct the personal massage apparatus to perform one or more tests that only a personal massage apparatus having an authentic serial number will be able to complete. Such tests may include one or more of: a motor test, a battery test, and/or a light test. If the personal massage apparatus is unable to perform these tests, the personal massage apparatus will be disabled from transmitting information to a second device.

If, however, the personal massage apparatus is able to perform said tests, the controller will be authorized to provide information pertaining to the apparatus to the second device. Information that may be passed from the personal massage apparatus to the second device may include one or more of the following: the personal massage apparatus's Chip ID, Information pertaining to the battery of the personal massage apparatus, the Media Access Control (“MAC”) Address of the personal massage apparatus, and/or the serial number of the personal massage apparatus. This information may then be transmitted to another device, such as a personal computer, tablet, mobile phone, database, server, computer program, operating system, or other suitable target. The serial number of the controller the process associated with the same can help to provide software updates to the personal massage apparatus and/or confirm authenticity of a personal massage apparatus.

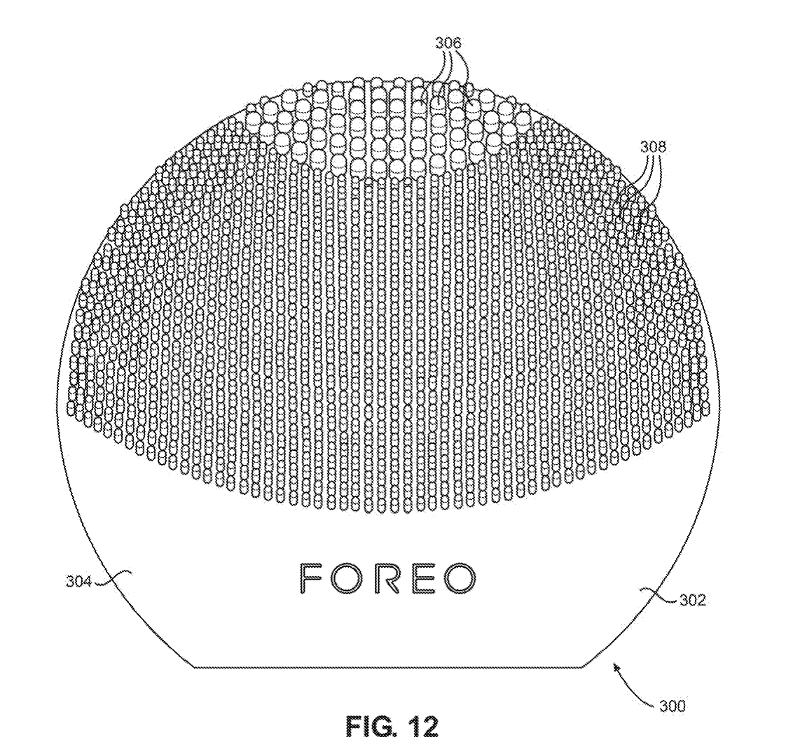

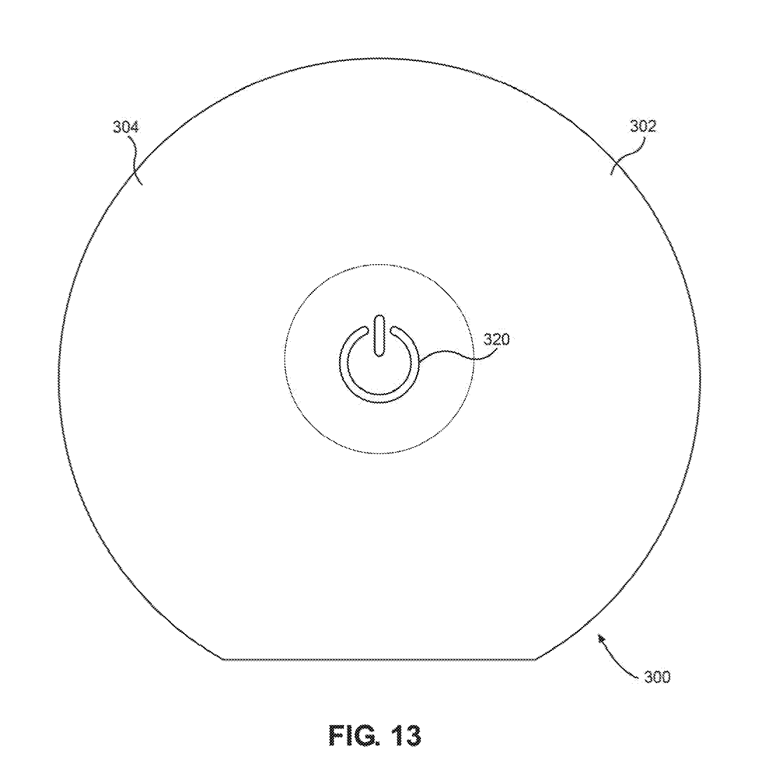

FIGS. 12 and 13 illustrate another example personal massage apparatus 300. The personal massage apparatus 300 is similar to the personal massage apparatus 2, shown in FIGS. 2, 3, 4, 5, 6, 7, 8, 9, and 10 except as detailed below. Thus, the personal massage apparatus 300 has a main body 302, an exterior covering 304 defining a first set of touch-points 306 and a second set of touch-points 308, a user control 320, and first and second motors configured to generate stochastic vibrations (not illustrated in the Figures). The first and second motors may be disposed in any of the configurations illustrated in FIGS. 1, 1A, 1B, 1C, or 1D in this embodiment.

In the illustrated embodiment, the base (not illustrated in the Figures) of the personal massage apparatus 300 is covered by the exterior covering 304. The base is configured to stand, unaided and without assistance from a second device, on a substantially flat surface.

Furthermore, the personal massage apparatus 300 does not include a jack through which to charge a lithium-ion battery; instead the power source comprises first and second removeable dry cell batteries.

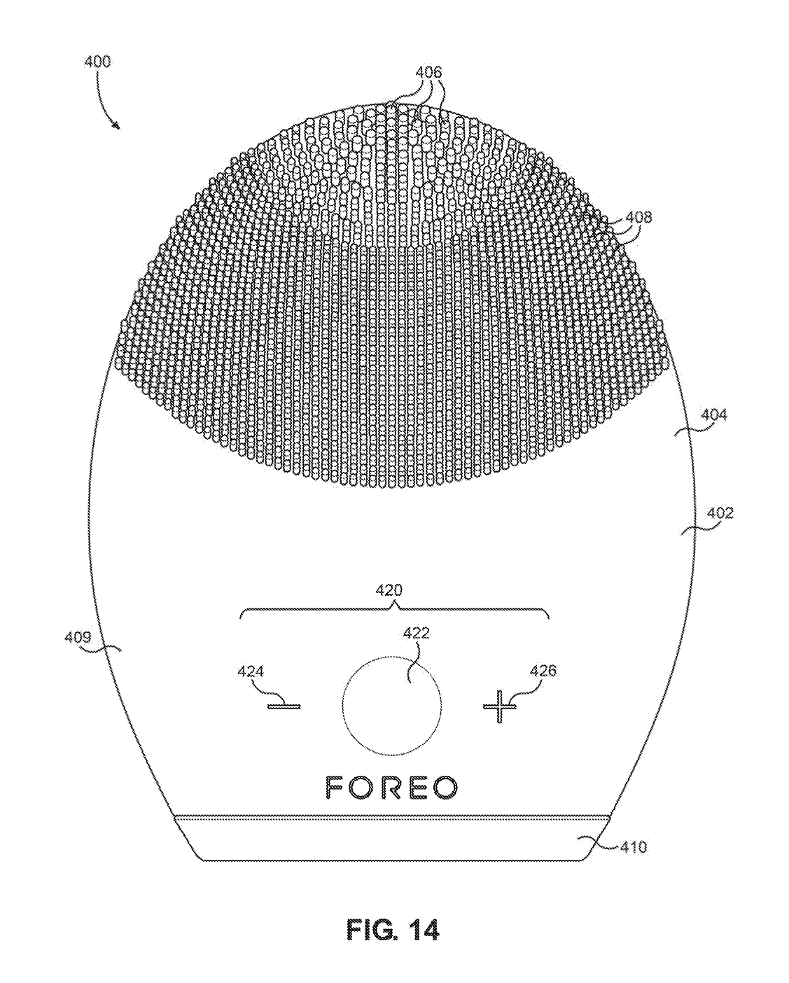

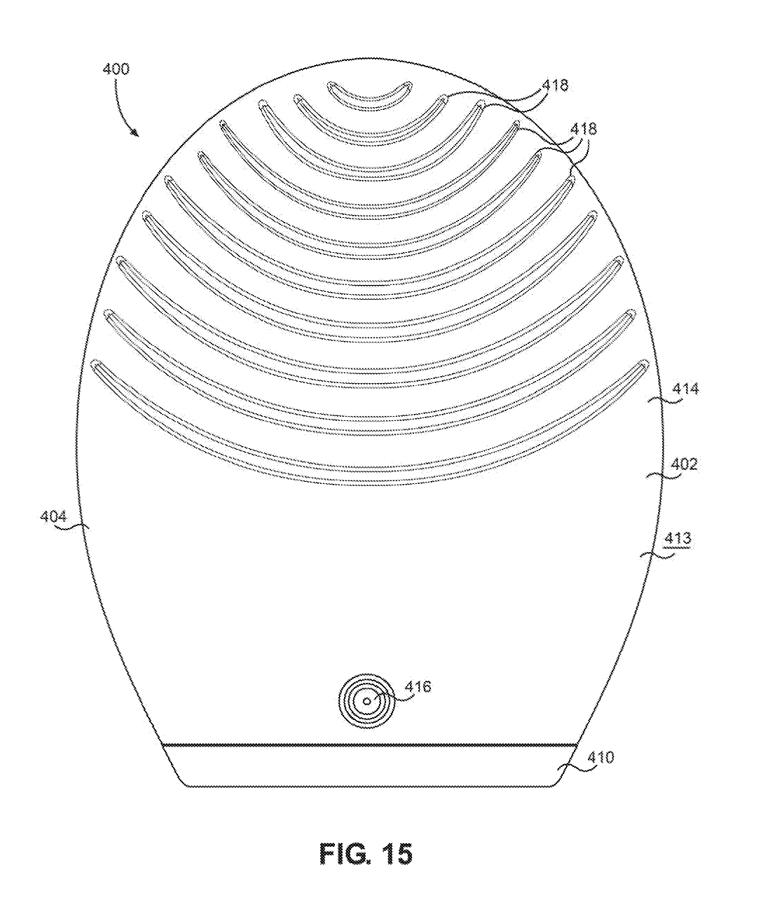

FIGS. 14 and 15 illustrate another example personal massage apparatus 400. The personal massage apparatus 400 is similar to the personal massage apparatus 2, shown in FIGS. 2, 3, 4, 5, 6, 7, 8, 9, and 10, except as detailed below. Thus, the personal massage apparatus 400 has a main body 402, an exterior covering 404 defining a first set of touch-points 406 and a second set of touch-points 408, user controls 420 comprising first, second, and third buttons 422, 424, 426, a substantially transparent base 410, a DC jack 416, and first and second motors configured to generate stochastic vibrations (not illustrated in the Figures). The embodiment illustrated in FIGS. 14 and 15, as compared to that illustrated in FIGS. 12 and 13, is more oval in shape.

In the illustrated embodiment, the second side 414 of the exterior covering 404 defines a set of ridges 418. Each ridge of the set of ridges 418 is elongated and raised away from a surface 413 of the second side 414. Each ridge of the set of ridges 418 is substantially arcuate in shape and spans the second side 414; that is, each ridge of the set of ridges 418 extends such that is nearly adjacent the first side 409 of the exterior covering 404 at its terminal end. However, in other embodiments, the ridges may have any size, shape, and alignment. A skilled artisan will be able to determine how to suitably configure the ridges based on various considerations, including the type of stochastic resonance vibrations generated by the personal massage apparatus and area that the personal massage apparatus is designed to activate. In various embodiments, the set of ridges may comprise one, two, three, four, five, or more than five ridges; alternatively, the second side may comprise no ridges or may comprise a set of touch-points, rather than ridges. In different embodiments, one or more of the ridges may extend from the tip of the first end to, or nearly to, the base. In other embodiments, the one or more of the ridges may not be arcuate.

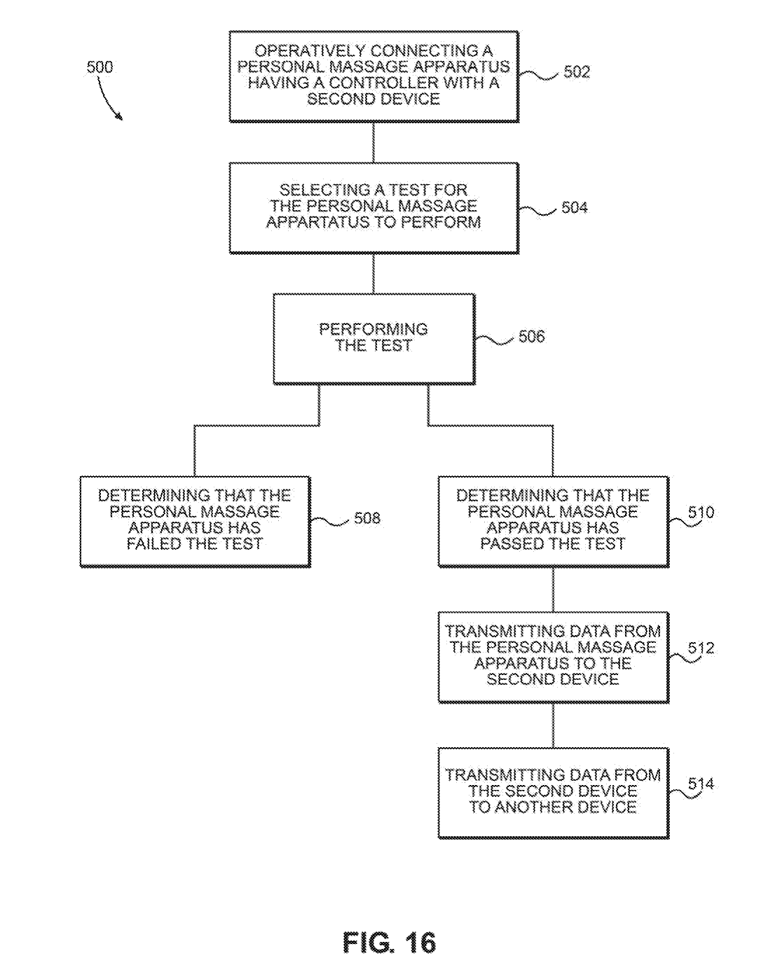

FIG. 16 is a flowchart representation of an example method 500 of verifying the authenticity of a personal massage apparatus. Performance of the method results in the confirmation or denial of a particular personal massage apparatus' authenticity.

An initial step 502 comprises operatively connecting a personal massage apparatus having a controller, such as personal massage apparatus 2 having controller 30, with a second device such as a personal computer, tablet, and/or mobile phone, for example. Any suitable personal massage apparatus and/or controller may be used, however, in other embodiments. The connection may be made wirelessly or via a wired connection.

Another step 504 comprises the second device selecting a particular test for the personal massage apparatus to perform. Such tests may include one or more of: a motor test, a battery test, and/or a light test in various embodiments. Any suitable test may be performed, though, in other embodiments.

Another step 506 comprises performing the test and/or test(s) selected in step 504.

Another step 508 comprises determining that the personal massage apparatus and/or its controller has failed the test(s) performed in step 506. In such an instance, the personal massage apparatus will be prevented from sending information pertaining to the personal massage apparatus to the second device. In other embodiments, the personal massage apparatus may be temporarily or permanently disabled after failure to perform the test(s).

Another step 510 comprises determining that the personal massage apparatus and/or its controller has passed the test(s) performed in step 506.

Another step 512 comprises transmitting data from the personal massage apparatus to the second device. The data transmitted generally contains information pertaining to the personal massage apparatus and may include one or more of the following: the personal massage apparatus's Chip ID, Information pertaining to the battery of the personal massage apparatus, the Media Access Control (“MAC”) Address of the personal massage apparatus, and/or the serial number of the personal massage apparatus. Any pertinent information may be passed to the second device, however, in various embodiments.

Optionally, another step 514 comprises transmitting data from the second device to another, additional device. The additional device may include one or more of: a personal computer, tablet, mobile phone, database, server, or other similar device. Any suitable additional device may be selected, however.

It is noted that it is advantageous to complete this method 500 in the order illustrated and described. However, any order is considered suitable.

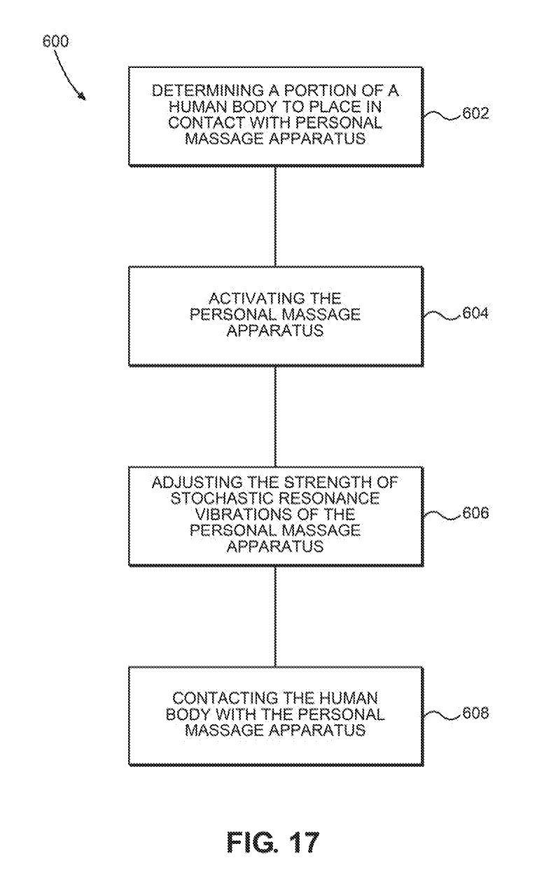

FIG. 17 is a flowchart representation of an example method 600 of providing stochastic resonance vibration to a portion of the human body through the use of a personal massage apparatus, such as one of personal massage apparatuses 2, 300, or 400.

An initial step 602 comprises determining a portion of a human body to place in contact with the personal massage apparatus.

Another step 604 comprises activating the personal massage apparatus via the control module such that the personal massage apparatus generates stochastic resonance vibrations.

Optionally, another step 606 comprises adjusting the strength of the stochastic resonance vibrations to a suitable level via the control module.

Another step 608 comprises contacting a portion of the human body with the personal massage apparatus in order to transfer stochastic resonance vibrations to the human body. In various embodiments, the portion of the human body may comprise bone, tissue, muscle, skin, the kidney, the heart and/or any other portion of the human body. In other embodiments, the stochastic resonance vibrations may impact the body by one or more of: activating muscle, tissue, bone, or skin, increasing skin tightness, increasing muscle tone, treating a disorder, and/or degrading kidney stones.

It is noted that the method 600 may be completed in the order illustrated and described. However, the steps may be completed in any order.

In all examples, a personal massage apparatus and its various components may be formed of any suitable material, including presently known and later-developed materials. A skilled artisan will be able to determine appropriate materials for an example personal massage apparatus based on various considerations, including the size and shape of the personal massage apparatus and/or the motors housed within the personal massage apparatus.

Those with ordinary skill in the art will appreciate that various modifications and alternatives for the described and illustrated embodiments can be developed in light of the overall teachings of the disclosure. Accordingly, the particular arrangements disclosed are intended to be illustrative only and not limiting as to the scope of the invention, which is to be given the full breadth of the appended claims and any and all equivalents thereof.

What is claimed is:

1. A personal massage apparatus configured to deliver vibration to a portion of a human body, comprising:
a main body having a first end;
a silicone exterior covering substantially all of the main body and defining a first textured surface area integrally forming part of the silicone exterior, the first textured surface area defining a first set of touch-points, each touch-point of the first set of touch-points having a diameter between about 0.5 millimeters and about 2.5 millimeters;
a first motor disposed within the main body and configured to generate vibration;
a second motor disposed within the main body and adapted to generate vibration, the first motor and the second motor being vibrationally connected and configured to cooperatively generate stochastic resonance vibration in the first end due to vibrational interference between the first motor and the second motor; and
at least one user control configured to operate the first motor and the second motor.

2. The personal massage apparatus of claim 1, wherein the second motor is disposed within the main body such that it is substantially parallel to the first motor.

3. The personal massage apparatus of claim 2, wherein the first motor and second motor are disposed side by side within the main body.

4. The personal massage apparatus of claim 3, wherein the first motor includes a first counterweight and the second motor includes a second counterweight.

5. The personal massage apparatus of claim 4, wherein the first counterweight is adjacent the second counterweight.

6. The personal massage apparatus of claim 1, wherein the second motor is disposed within the main body such that it is substantially perpendicular to the first motor.

7. The personal massage apparatus of claim 6, wherein the first motor includes a first counterweight and the second motor includes a second counterweight; and
wherein the first counterweight is adjacent the second counterweight.

8. The personal massage apparatus of claim 1, wherein the first motor and the second motor are disposed within the main body such that they form a V-shape.

9. The personal massage apparatus of claim 1, wherein the first motor and the second motor are electromagnetic motors.

10. The personal massage apparatus of claim 1, wherein the first motor vibrates at a constant frequency and the second motor vibrates discontinuously.

11. The personal massage apparatus of claim 10, wherein the second motor vibrates in short pulses.

12. The personal massage apparatus of claim 1, wherein the first motor generates a first discontinuous vibration and the second motor generates a second discontinuous vibration.

13. The personal massage apparatus of claim 1, wherein the first motor operates at a fixed vibrational frequency, and the second motor operates continuously in a range of variable frequencies.

14. A personal massage apparatus configured to deliver vibration to a portion of a human body, comprising:
a main body having a first end;
a silicone exterior covering substantially all of the main body and defining first and second textured surface areas integrally forming part of the silicone exterior, the first textured surface area defining a first set of touch-points, the second textured surface area defining a second set of touch-points, each touch-point of the first and second sets of touch-points having a diameter between about 0.5 millimeters and about 2.5 millimeters;
a first motor disposed within the main body and configured to generate vibration;
a second motor disposed within the main body and adapted to generate vibration, the first motor and the second motor being vibrationally connected and configured to cooperatively generate stochastic resonance vibration in the first end due to vibrational interference between the first motor and the second motor, the second motor disposed within the main body such that it is substantially perpendicular to the first motor; and
at least one user control configured to operate the first motor and the second motor.

15. The personal massage apparatus of claim 14, wherein the first motor operates at a frequency between about 100 Hz and about 200 Hz.

16. The personal massage apparatus of claim 15, wherein the second motor operates at a frequency between about 3 Hz and about 10 Hz.

17. The personal massage apparatus of claim 16, wherein the first motor vibrates at a constant frequency and the second motor vibrates discontinuously.

18. The personal massage apparatus of claim 14, wherein the first motor is disposed closer to the first end of the main body than is the second motor.

19. A personal massage apparatus configured to deliver vibration to a portion of a human body, comprising:
a main body including a substantially flat base configured to stand unaided on a substantially flat surface;
a silicone exterior covering substantially all of an exterior of the main body, the silicone exterior having a first side defining first and second textured surface areas that are integrally formed with the silicone exterior, the first textured surface area comprising a first set of touch-points and the second textured surface area comprising a second set of touch-points, each touch-point of the second set of touch-points having a diameter that is smaller than a diameter of each touch-point of the first set of touch-points, the second set of touch-points being disposed closer to the base than the first set of touch-points, each touch-point of the first set of touch-points and the second set of touch-points having a diameter between about 0.5 and about 2.5 millimeters;
a first motor disposed within the main body and configured to generate vibration;
a second motor disposed within the main body and adapted to generate vibration, the first motor and the second motor being vibrationally connected and configured to cooperatively generate stochastic resonance vibration in the first end due to vibrational interference between the first motor and the second motor, the second motor disposed within the main body such that it is substantially parallel to the first motor; and
at least one user control configured to operate the first motor and the second motor.

20. The personal massage apparatus of claim 19, wherein the silicone exterior has a second side opposite the first side, the second side defining a third textured surface area that is integrally formed with the silicone exterior, the third textured surface area comprising a third set of touch-points.
